(19) United States
(12) Patent Application Publication
(10) Pub. No.: US 2023/0026396 A1
(43) Pub. Date: Jan. 26, 2023

(54) Stitching Pattern Tufted Geotextile For Infill Stability

(71) Applicant: Watershed Geosynthetics LLC, Alpharetta, GA (US)

(72) Inventors: Michael R Ayers, Johns Creek, GA (US); S Kyle Ehman, Milton, GA (US); William Delaney Lewis, Downsville, LA (US); Jose L Urrutia, Suwanee, GA (US)

(73) Assignee: Watershed Geosynthetics LLC, Alpharetta, GA (US)

(21) Appl. No.: 17/786,283

(22) PCT Filed: Dec. 18, 2020
(86) PCT No.: PCT/US2020/066035

§ 371 Date: Jun. 16, 2022

Related U.S. Application Data
(60) Provisional application No. 62/950,752, filed on Dec. 19, 2019.

(51) Int. Cl. B09B 1/00; E01C 13/08; E02D 17/20

(52) U.S. Cl. CPC B09B 1/004; E01C 13/08; E02D 17/202

(57) ABSTRACT

A tufted geotextile includes a backing sheet tufted to resemble grass with polymeric yarns that when tufted form loops or bridges on a back side and tufts that extend as grass-like blades from an upper surface. Each line of tuft blades is tufted with a repeating stitching pattern generally of a weft portion along a tuft line first axis and warp portions disposed in a first direction at an angle to the first weft portion. The tufts define interstices that define cells that receive and trap infill for resisting displacement and movement of the infill under loading such as hydraulic flow or granular flow due to wind, seismic, vibrations, expansion and contraction loading, and the like. Each line of tuft blades is sewn along an alternating, interconnected “C-shaped” stitching pattern or square wave stitching pattern to define diverting tufts to restrict infill displacement and water flow.

### TECHNICAL FIELD

The present invention relates to geotextile sheets for land site covers and closure systems. More particularly, the present invention relates to a stitching-pattern geotextile providing for infill stability by increasing shear resistance to infill displacement or granular flow from loading such as from hydraulic shear, wind, seismic, vibrations, expansion and contraction loading, and the like other loading forces directed onto a ground cover system.

In this application, the following terms will be understood to have the indicated definitions:

waste sites—refers to earthen berms or piles and to sites where waste is deposited, such as landfills, phosphogypsum stacks, environmentally impacted land, leach pads, mining spoils and environmental closures or material stockpiles that require a closure or cover system to protect proximate and remote environments such as local subsurface ground and ground water table and downstream waterways and bodies and subsurface ground;

synthetic grass—refers to a composite of at least one geotextile (woven or nonwoven) tufted or knitted with synthetic yarns or strands that has the appearance of grass;

geomembrane—refers to a conventional or textured polymeric-material sheets, such as high density polyethylene, very low density polyethylene, linear low density polyethylene, polyvinyl chloride, etc.

granular flow—displacement with fluid characteristics of a hard granular material; fluidal displacement or movement of a granular material caused by loading forces on the granular material; for example, movement of sand within an hour glass, movement of granular infill in a tufted geotextile application.

geotextile—refers to a flexible material consisting of a network of natural or artificial fibers for ground covering purposes;

stitching pattern geosynthetic —refers to any tufted, knitted, woven, air-laid, non-woven, crocheted, knotted, felted, braided or fabric geotextile with a structured stitching pattern of grass-like blades extending from an upper surface providing increased resistance to infill displacement.

### BACKGROUND OF THE INVENTION

Large area land sites occupied for use as waste sites, landfills, stockpiles, and coal-power plant disposal fields remain open typically for a number of years for receiving materials for subgrade disposal storage including waste materials, mining spoils or power plant wastes and ash, landfill trash and municipal solids and liquids wastes. Waste sites typically have steep slopes rising from a toe or base to an upper elevated apex or peak. The elevation over time with deposits of fill materials may typically reach several hundred feet above the toe. While steep slopes allow increased storage volume, steep slopes experience significantly high shear hydraulic forces from rainfall events. These forces occur in response to the fill materials loaded within a vertical portion of the area allocated for the landfill and also arise from precipitation and water flow such as from rain fall on the waste site that generates high volumes of water flowing downwardly to the toe. Steep slopes often experience large and rapid run-off.

Upon reaching an appropriate capacity for the particular site, the site is closed to receiving additional waste materials. In the interim, however, filled portions of large area land sites may gainfully use a covering to reduce water inflow into the land site. The covering may include in-fill materials to secure the covering in place over a ground surface. Some such temporary coverings may require ten or more years expected longevity prior to covering by a long-term solution (for example, forty years or more longevity).

The structure of landfills and waste sites are subject to environmental regulations for construction, operation, and closing after design capacity is reached. Construction regulations routinely require lining of a base of a landfill with an impermeable geomembrane liner. The liner restricts the flow of water and contaminates from the deposited waste fill material and precipitation into ground water below the landfill. Rather, water is channeled to a liquid treatment facility prior to discharge. For the case of the top closure liners, the geomembrane may slip or move in response to shear forces, and slippage may cause damage to the geomembrane as well as site failure and avalanche-type sliding collapse of the fill material. Such failure and damage incurs significant cost to remedy, particular if the failure causes openings in the liner which then must be replaced or fixed in order to maintain impermeability of the closure area.

Land site filling operations typically involve depositing waste materials in specific laydown areas. The deposited waste materials are often covered with a soil layer to form a cell. Adjacent cells are formed with subsequently deposited waste materials. Closure of the site upon reaching design capacity involves overlaying a covering of sealing materials on exposed surfaces of the landfill. Notwithstanding closure, the land sites have ongoing costs including groundwater monitoring for leaching of wastes and contaminates into water systems and streams, collection and discharge of gases from the waste site, and periodic maintenance to maintain the closure covering. Previous efforts to close such sites involved overlaying the site with an earthen soil layer. High water flow however, erodes soil covering, and vegetation providing resistance to erosion, requires cutting and growth control. Further, high water flow requires installation of benches around the perimeter of the side spaced typically at 100 feet intervals to minimize erosion of the cover soils. The benches are substantially leveled broad interruptions or steps in the slope and extend along a contour. The bench typically includes a guttering system for receiving water flow from the slope and channel the water to a catch basin for storage, treatment if any, and discharge to a pond water system or waterway. The bench may also provide a roadway for vehicles to move along the sloped ground.

In recent years, large area sites are closed with covering formed with elongated sheets of an impermeable geomembrane. The geomembrane seals the site from inflow of water, such as from rain and snow, and thereby prevents wastes and contaminates from infiltration into streams and ground water. The membranes often must be secured with anchors and trench systems to resist wind uplift. However, it is disfavored to use vertical anchors or rods that pierce the geomembrane to prevent openings that may allow water flow into the underlying fill materials in the waste site.

To provide aesthetics and water flow control, tufted geotextiles have been overlaid on exposed membranes. Our prior U.S. Pat. No. 8,403,597 discloses a cover system for waste sites effective in resisting wind uplift and remaining in-place with frictional contact between the geomembrane and the geotextile and describes a synthetic underlying geomembrane for water drainage without eroding an infill within interstices of the tufted turf. The tufted geotextile provides a field of synthetic grasses with short blades extending from the geotextile backing sheet. In such installations, granular material infill may fill interstices of the tufts. The granular material assists with loading to resist wind uplift, filters water flowing through the geotextile into a synthetic drainage on the geomembrane, and assisting with reducing exposure of the geotextile to UV and deterioration. The granular material also assists with drivability of motor vehicles on the cover.

While meeting closure system needs in the industry, there are opportunities for reduced costs in materials and maintenance while increasing longevity of the installed cover. The water flow creates hydraulic shear loading and may cause the granular infill material to be displaced and move, and thus require periodic maintenance to replace infill in areas that the infill has thinned. While hydraulic loading forces are typically more frequent events, there are also other loading forces may induce infill displacement including seismic events, ground vibrations, cover expansion and contractions (wrinkles in the tufted geotextile may be generated), and wind. Furthermore, large outdoor landfill sites are often steeply sloped sites and geotextile/geomembrane stretching may create drum effects that dislodge infill (i.e., dry flow, displacement or movement of granular infill). There are alternatives that reduce infill movement (i.e., increase infill shear resistance). While these have benefits as to maintenance for installed systems, increased tuft gauge and reduced tuft blade lengths have the countering drawbacks of reduced friction resistance of the tufted geotextile and geomembrane that restricts applications to less steeply sloped installations due to reduced friction resistance increases slip conditions. However, a uniform infill thickness across the installed cover enables a consistent water head that drives the rainfall water flow through the geotextile faster yet with a smaller drainage profile and increasing drainage length.

Further, the infill displacement tends to increase UV exposure and lead to degradation of the tufted covering, and thus reduce the operational life for a cover or a closure system for waste sites.

The need for benches also incurs installation and maintenance costs. The cover systems also typically involve the use of motor vehicles over the installed cover system for inspection and maintenance purposes. The overlaid tufted geotextile/geomembrane system with granular infill preferably accommodates the use of motor vehicles while resisting cutting and trenching and damaging the frictional interface that retains the geotextile overlaid on slopes of the covered landfill.

Accordingly, there is a need in the art for a tufted geotextile ground cover that provides infill stability by shear resistance to displacement from loading forces imposed on the ground cover. It is to such that the present invention is directed.

### SUMMARY OF THE INVENTION

The present invention meets the need in the art by providing a geotextile cover system for use with covering and closing land surfaces, comprising at least one backing sheet tufted with yarns that extend from the backing sheet as simulated grass blades having interstices therebetween and formed in spaced-apart lines of tufts, each said line of tufts having a stepped tuft line first axis and a spaced-apart tuft line second axis of repeating spaced-apart tufts, said line of tufts defined by repeating patterns of a first weft portion, a first warp portion disposed in a first direction at an angle to the first weft portion, a second weft portion, and a second warp portion in a second opposing direction at an angle to the second weft portion, each portion terminating in a tuft of yarn extending from a first face of the backing sheet as blades of simulated grass with interstices therebetween for receiving infill, said backing sheet porous for permitting water flow through the tufted geotextile, said lines of tufts for resisting shear displacement and movement of the infill received in the interstices between adjacent tufts arising from granular flow loading forces for steeply sloped land site covering and closure applications.

In another aspect, the present invention provides a cover system with high shear resistance for granular infill stability, comprising a geomembrane; and a synthetic grass composite comprising a geotextile having a backing sheet with a plurality of spaced-apart tufts tufted with one or more synthetic yarns to form a plurality of elongated blades extending therefrom, said tufts tufted in stepped first and second lines of repeating tufts defined by a first weft portion, a first warp portion disposed in a first direction at an angle to the first weft portion, a second weft portion, and a second warp portion in a second opposing direction at an angle to the second weft portion, the tufts defining interstices therebetween from the geotextile to a fill plane defined by about a distal extent of the blades, and porous for permitting water flow through the backing sheet, to resist displacement and movement of the infill received in the interstices between adjacent tufts under loading. The cover system for overlying a ground surface for covering purposes while resisting granular infill displacement in response to shear loading including water flow and dry granular flow of infill resulting from wind, seismic, and thermodynamics of the synthetic geotextile that results in wrinkles in the cover.

In yet another aspect, the present invention provides a synthetic turf cover system for erosion protection, wherein the synthetic turf cover system comprises a backing sheet; and synthetic grass blades extending above and through said backing sheet, said synthetic grass blades being tufted into said backing sheet in a plurality of laterally offset, mutually aligned square wave patterns.

In yet another aspect, the present invention provides a synthetic turf cover system for erosion protection, wherein the synthetic turf cover system comprises a backing sheet; and synthetic grass blades extending above and through said backing sheet, said synthetic grass blades being tufted into said backing sheet in a plurality of tufted sew lines, each said tufted sew line having a plurality of longitudinal portions and a plurality of lateral portions, and wherein each adjacent pair of said longitudinal portions of said plurality of longitudinal portions is spaced from each other by one said lateral portion of said plurality of lateral portions.

Objects, advantages, and features of the present invention will be readily apparent upon a reading of the following detailed description in conjunction with the drawings.

### BRIEF DESCRIPTION OF THE DRAWINGS

FIG. 1 illustrates in perspective view a tufted ground covering system in accordance with the present invention.

FIG. 1A illustrates in cross-sectional view the tufted ground covering system illustrated in FIG. 1

FIG. 2 illustrates in perspective view a bridging side of a backing sheet for the tufted ground covering system tufted with one or more synthetic yarns in stepped lines defined by a first weft portion on a first axis, a first warp portion disposed in a first direction to the first weft portion, a second weft portion on a second axis spaced from the first axis, and a second warp portion disposed in a second opposing direction to the second weft portion.

FIG. 3A illustrates in schematic diagram a tufting line stitching pattern in accordance with the present invention.

FIG. 3B illustrates in schematic diagram the tufts of the tufting line stitching pattern and water flow channels having increased time of concentration.

FIG. 3C illustrates in schematic diagram a second embodiment of a tufting line stitching pattern in accordance with the present invention.

FIG. 3D illustrates in schematic diagram a third embodiment of a tufting line stitching pattern in accordance with the present invention.

FIG. 4 illustrates in perspective exploded view a ground covering system having a first and a second backing sheet tufted with a stitching pattern in accordance with the present invention.

FIG. 5 illustrates in exploded cross-sectional view the ground covering system deployed as a covering over a land site in accordance with the present invention.

FIG. 6 illustrates in schematic cross-sectional view the ground covering system installed as a component of a closure system in accordance with the present invention on a steep slope land site.

FIGS. 7A and 7B illustrate geomembranes useful with the component closure system illustrated in FIG. 6 having surface treatment for frictional resistance to movement.

FIGS. 8A and 8B, 9A and 9B, 10A and 10B, and 11A and 11B illustrate alternate embodiments of tufting pattern tufted synthetic grass ground covers in accordance with the present invention.

### DETAILED DESCRIPTION

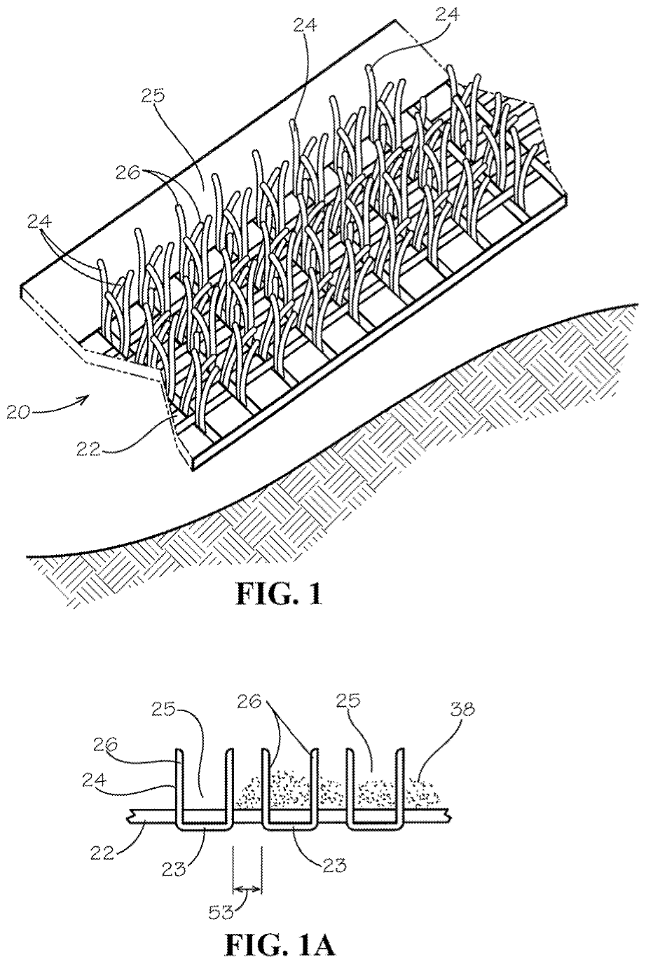

With reference to the drawings, in which like parts have like identifiers, FIG. 1 illustrates in perspective view a tufted ground covering system or geotextile 20 in accordance with the present invention. The present invention is directed to an improved tufted geotextile for use with covering and closing land surfaces structured for infill stability by shear resistance to displacement from loading forces (such as generated by hydraulic, wind, seismic, vibrations, expansion and contraction loading, and the like). The tufted geotextile comprises at least one backing sheet tufted with yarns that extend from the backing sheet as simulated grass blades having interstices therebetween and formed in lines of tufts having a stepped tuft line first axis and a spaced-apart tuft line second axis of repeating tufts defined by a first weft portion or a lateral or transverse portion, a first warp portion or a longitudinal portion disposed in a first direction at an angle to the first weft portion, a second weft portion or second lateral or transverse portion, and a second warp portion or second longitudinal portion in a second opposing direction at an angle to the second weft portion, to define tufts of yarns extending from a first face of the backing sheet as blades of simulated grass with interstices therebetween for receiving infill, and porous for permitting water flow through the geotextile, for resisting displacement and movement of the infill received in the interstices between adjacent tufts arising from granular flow loading forces.

More particularly, in the plurality of tufted lines, each has a plurality of the longitudinal portions and a plurality of the lateral portions, and wherein each adjacent pair of said longitudinal portions of said plurality of longitudinal portions is spaced from each other by one said lateral portion of said plurality of lateral portions. The tufted geotextile readily overlies a ground surface for covering purposes as well as installs as a component in a closure system that uses an impermeable geomembrane for sealing closure, which stepped lines of tufts of the tufted geotextile exhibits improved shear resistance to infill displacement for steeply sloped land site covering and closure applications.

The tufted geotextile provides desired increased infill stability and resistance to displacement and movement, such as flow away caused by loading forces, for example but not limited to loading forces of water flow across the geotextile particularly during large hydraulic shear events on covered sloped ground surfaces experiencing water flow such as from rain storms, whereby the granular infill (typically sand or a sand mixture) remains stabilized on the geotextile and maintaining the geotextile as a ground cover secured to the ground surface or to the geomembrane below when used as a component of a cover system.

Further, unexpected and surprisingly the geotextile experiences increased frictional contact that resists geotextile creep movement and slippage relative to the surface on which the bottom surface of the geotextile contacts engagingly for surface covering purposes. This unexpected improved performance allows use of an alternate impermeable membrane in a composite covering system useful for long term ground site closure purposes. The geomembrane provides an impermeable barrier restricting inflow or seepage of water into the covered ground site. The alternate textured geomembrane may thereby be of lower cost for materials, manufacturing, and handling for installation than prior geomembranes, with a thinner cross-sectional thickness, and configured with opposing surface textured faces for selectively positioning to the ground surface and back surface of the geotextile, or with opposing faces having spikes or projections for engaging the ground surface and the backing sheet. The texturing of the textured face may be a surface scarring treatment (i.e., defining grooves and ridges) or a field of projecting stubs or peaked tapered spike or pins, which engage the warp portions of the tufting yarns on the bottom surface of the geotextile backing sheet for increased frictional engagement between the tufted geotextile and the geomembrane and/or the ground surface. Generally, a smooth surface geomembrane is less preferable as lacking dimensional stability, without a significant cost differential, and less drainage capacity.

Further, the tufted geotextile exhibits surprising increased time of concentration as to water flow during hydraulic shear events with reduction in water flow velocity and shear across the tufted geotextile and increased flow through the permeable backing sheet either into the ground below or in a composite system with an impermeable geomembrane ground cover for flow below the tufted geotextile to drainage.

The interstices of the tufts in the geotextile of the present invention create tufted cells that maintain a selected thickness of the sand (or granular) infill with resistance to displacement, and contributes to a uniform driving head on the infill while increasing drainage critical length for water flow across the cover system. The geotextile in accordance with the present invention facilitates load force transmissivity within the infill trapped in the tuft cells with increased drainage critical length.

The tufted geotextile as recited above, wherein the first weft portion and the second weft portion are of an equal length.

The tufted geotextile as recited above, wherein the first warp portion and the second warp portion are of an equal length.

The tufted geotextile as recited above, wherein the first warp portion comprises a first segment and a second segment each terminating in a tuft extending upwardly from an opposing side of the backing sheet.

The tufted geotextile as recited above, wherein the first weft portion and the second weft portion are of an equal first length, the first warp portion and the second warp portion are of an equal second length, and the second length is substantially equal to the first length.

The tufted geotextile as recited above, wherein the first warp portion and the second warp portion each comprises a first segment and a second segment with each segment terminating in a tuft extending upwardly from an opposing side of the backing sheet.

The tufted geotextile as recited above, wherein the first weft portion and the second weft portion are of an equal first length, the first warp portion and the second warp portion are of an equal second length, and the second length is greater than the first length.

The tufted geotextile as recited above, wherein adjacent lines of tufting have a tuft gauge for closely spacing an initiating apex of the first warp portion relative to the terminating apex of the first warp portion of the adjacent line for minimizing an interstitial gap between the adjacent tufts of the adjacent lines of tufting.

The tufted geotextile as recited above, in which the backing sheet has a basis weight of about 2 ounces per square yard to about 20 ounces per square yard.

The tufted geotextile as recited above, in which the backing sheet comprises a single-sheet backing sheet or alternatively, two or more backing sheets tufted together with polymeric yarns for defining the tufts extending from a surface of the first backing sheet.

The tufted geotextile recited above, in which the backing sheet comprises a first backing sheet and a second backing sheet tufted together with polymeric yarns for defining the tufts extending from a surface of the first backing sheet.

The tufted geotextile as recited above, wherein the first backing sheet and the second backing sheet each have a basis weight totaling about 2 ounces per square yard to about 20 ounces per square yard.

The tufted geotextile as recited above, wherein the first backing sheet and the second backing sheet each have a basis weight of about 2 ounces per square yard to about 20 ounces per square yard.

The tufted geotextile as recited above, wherein the polymeric yarns include UV resistant additives.

The tufted geotextile as recited above, wherein the polymeric yarns for the backing sheet include fire resistant additives.

The tufted geotextile as recited above, wherein the tufts in the adjacent stepped rows have a spacing gauge and spacing of adjacent rows to dispose tufts as a diverter structure in a water flow of interstices between adjacent lines of tufts.

In another aspect, the present invention meets the need in the land site coverage art by providing a cover system with high shear resistance for granular infill stability, comprising a geomembrane and a synthetic grass composite comprising a geotextile having a backing sheet with a plurality of spaced-apart tufts tufted with one or more synthetic yarns to form a plurality of elongated blades extending therefrom in stepped first and second lines of repeating tufts defined by a first weft portion, a first warp portion disposed in a first direction at an angle to the first weft portion, a second weft portion, and a second warp portion in a second opposing direction at an angle to the second weft portion, the tufts defining interstices therebetween from the geotextile to a fill plane defined by about a distal extent of the blades, and porous for permitting water flow through the backing sheet, to resist displacement and movement of the infill received in the interstices between adjacent tufts under loading. The combination geomembrane and tufted geotextile readily overlies a ground surface for covering purposes as well as installs as a closure system that uses the geomembrane/geotextile interface for shear resistance for a land site such as a landfill, roadway foundation, backfill support for retaining walls, and other soil/waste site applications. The interstices receive the infill, whereby the extending blades cooperatively with the infill, shadow the interstices from the geotextile to proximate the fill plane from UV exposure and resisting granular infill displacement in response to shear loading including water flow and dry granular flow of infill resulting from wind, seismic, thermodynamics of the synthetic geotextile (and geomembrane in composite systems) that results in wrinkles in the cover.

The cover system as recited above, wherein the first weft portion and the second weft portion in the tufted geotextile are of an equal length.

The cover system as recited above, wherein the first warp portion and the second warp portion tufted geotextile are of an equal length.

The cover system as recited above, wherein the first warp portion comprises a first segment and a second segment each terminating in a tuft extending upwardly from an opposing side of the backing sheet.

The cover system as recited above, wherein the first weft portion and the second weft portion in the tufted geotextile are of an equal first length, the first warp portion and the second warp portion in the tufted geotextile are of an equal second length, and the second length is substantially equal to the first length.

The cover system as recited above, wherein the first warp portion and the second warp portion each comprises a first segment and a second segment with each segment terminating in a tuft extending upwardly from an opposing side of the backing sheet.

The cover system as recited above, wherein the first weft portion and the second weft portion in the tufted geotextile are of an equal first length, the first warp portion and the second warp portion in the tufted geotextile are of an equal second length, and the second length is greater than the first length.

The cover system as recited above, wherein adjacent lines of tufting have a tuft gauge for closely spacing an initiating apex of the first warp portion relative to the terminating apex of the first warp portion of the adjacent line for minimizing an interstitial gap between the adjacent tufts of the adjacent lines of tufting.

The cover system recited above, wherein the first geotextile has a basis weight of at least about 2 ounces per square yard.

The cover system recited above, further comprising a second geotextile tufted to the first geotextile.

The cover system recited above, wherein the first geotextile and the second geotextile each have a respective basis weight totaling about at least 2 ounces per square yard.

The cover system recited above, wherein the first geotextile and the second geotextile each have a basis weight of about at least 2 ounces per square yard.

The cover system recited above, wherein the tufts are tufted in a line with a tuft gauge of about 27 tufts per foot machine direction.

The cover system recited above, where adjacent tuft lines are spaced on about a ¼ inch center tuft gauge.

The cover system recited above, wherein the geotextile has a tensile strength of about 800 pounds per foot to about 4,000 pounds per foot.

The cover system recited above, wherein the geomembrane provides a frictional interface resistant to shear forces or a mechanical interface relative to a ground surface for resisting cover system sliding thereover.

The cover system recited above, wherein the geomembrane may have opposing textured surfaces or surfaces defining extending projections, for engaging a ground surface below and the textured geotextile above.

The cover system recited above, wherein the polymeric yarns include UV resistant additives.

The cover system recited above, wherein the geotextile has a fire retardant additive.

More particularly the tufted geotextile 20 comprises a backing sheet 22 tufted to resemble grass with polymeric yarns that when tufted form loops or bridges generally 23 (see cross-sectional view in FIG. 1A) on a back or bridging side of the backing sheet to form a plurality of tufts 24 that extend as grass-like blades 26 from an upper surface of the backing sheet. In the illustrated embodiment, the backing sheet 22 is woven as shown generally in detailed view with warp and waft yarns, although a nonwoven sheet may be used. Each line of tuft blades is tufted with repeated steps on a tuft line first axis and a spaced-apart tuft line second axis, for example, warp and weft yarn tufting (i.e., longitudinal and transverse tufting).

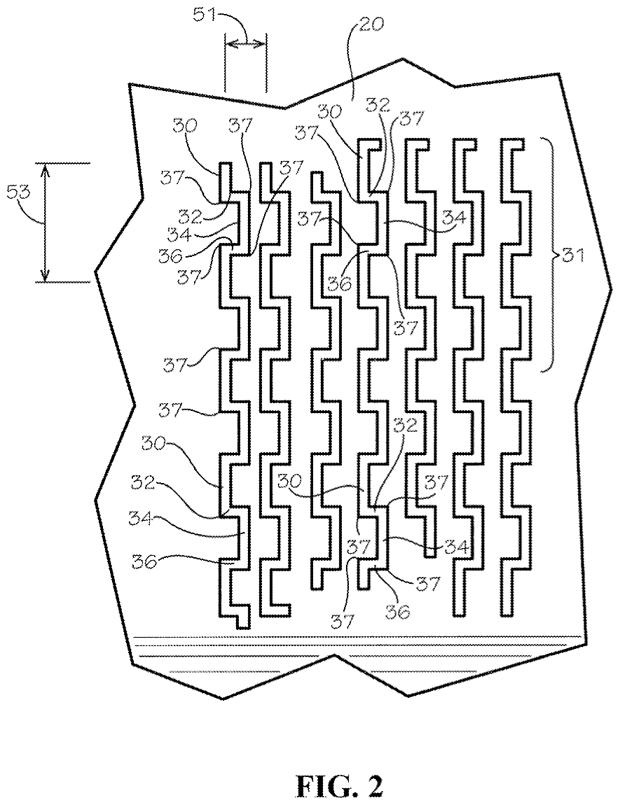

With reference to FIG. 2 that illustrates a cross-sectional view of the backing sheet 22, the lines of the tufting yarns form bridges 23 on the bridging or back side of the backing sheet 22 with a repeating stitching pattern generally 31 of a first weft portion 30 (transverse) along a tuft line first axis, a first warp portion 32 (longitudinal) disposed in a first direction at an angle to the first weft portion, a second weft portion 34 (transverse) along a spaced-apart tuft line second axis, and a second warp portion 36 (longitudinal) disposed in a second opposing direction at an angle to the second weft portion, each preferably terminating with the tuft 24 extending from the opposing surface of the backing sheet. The warp portions are illustrated as perpendicular relative to the weft portions but may be disposed at an oblique angle, such that the second tuft line second axis is spaced from the first tuff line axis. The tufts 24 define interstices 25 therebetween from the upper surface of the backing sheet to a fill plane 49 defined by about a distal extent of the blades of the geotextile. The backing sheet is permeable or porous for permitting water flow therethrough. A tuft 24 is preferably formed at each corner, turn, crux, or apex 37 of the longitudinal portion or weft portion 30, 34 and lateral portion of warp portions 32, 36 of the repeating stitching patterns of tufting. In the embodiments having multiple weft portion segments, each segment preferably terminates in a tuft. The interstices 25 define cells that receive and trap infill for resisting displacement and movement of the infill under loading such as hydraulic flow or granular flow due to wind, seismic, vibrations, expansion and contraction loading, and the like.

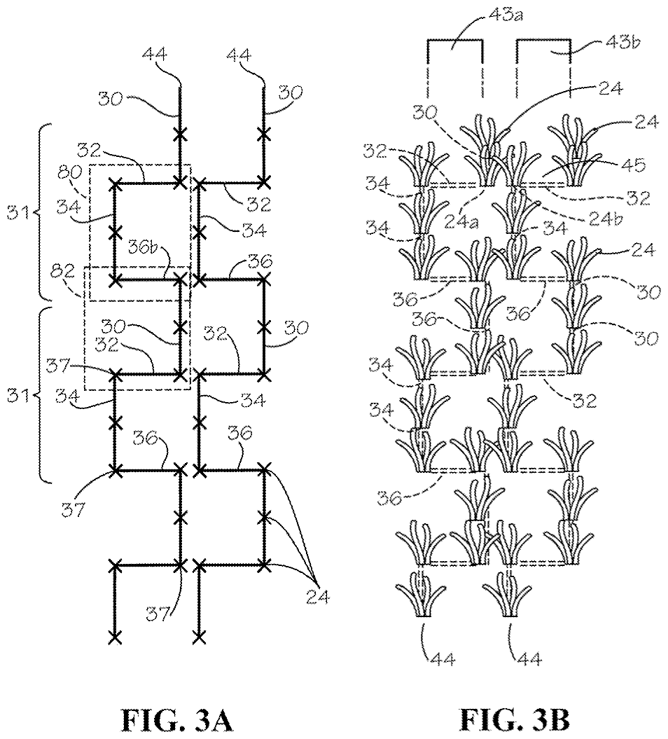

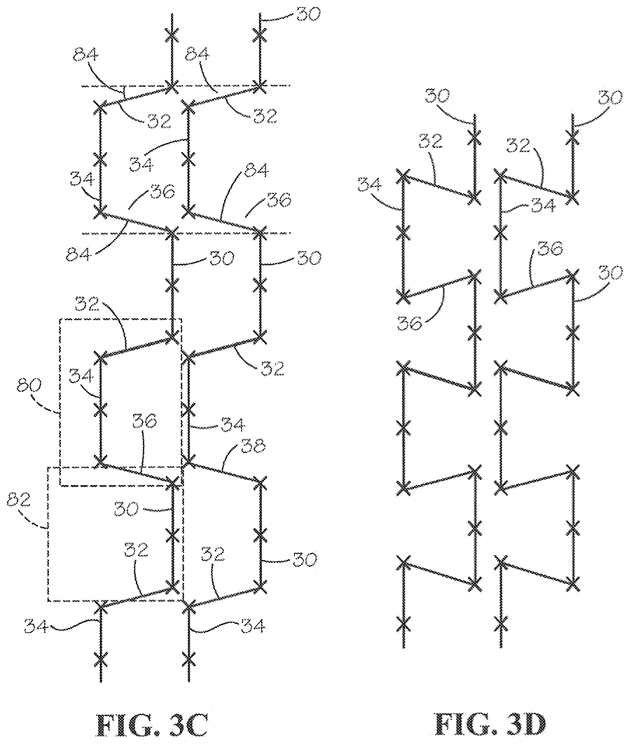

The warp portions 32, 36 define a step from and return to the generally weft direction of the stepped tufts defined by the tuft line first axis and tuft line second axis, which step direction is at an angle 84 relative to the weft direction of the line. The angle 84 generally is from an oblique angle of about 45 degrees to about 90 degrees, to perpendicular, more particularly at an angle of about 75 degrees to 90 degrees (as illustrated in FIG. 3C), and preferably at an angle of about 85 degrees to 90 degrees (FIG. 3A), whereby the tufting line steps in a warp direction for a selected tufting in the tuft line second axis spaced from the tuft line first axis of the first warp portion and return steps in an opposite warp direction for tufting in the line of the first warp portion. Preferably, the oblique angle of the stepped direction of the first and second weft portions are angularly substantially perpendicular or perpendicular to the first and second weft portions and define an alternating, interconnected “C-shaped” stitching pattern.

The tern alternating, interconnecting C-shaped stitching pattern is meant to identify a stitching pattern wherein the bottom leg or weft portion of an upper C-shaped stitching pattern is also the top leg or weft portion of a lower C-shaped stitching pattern immediately below the upper C-shaped stitching pattern, i.e., both C-shaped stitching patterns have a common leg or weft portion. The “alternating” aspect of the term alternating, interconnecting C-shaped stitching pattern is that each adjacent C-shaped stitching pattern faces in an opposite direction to the interconnected or immediately adjacent C-shaped stitching pattern.

For example, in FIG. 3A, the first complete C-shaped stitching pattern 80 (denominated by a broken line box) has the open portion of the C facing towards the right as shown on the drawing sheet. The next C-shaped stitching pattern 82 (denominated by a broken line box) immediately below the first C-shaped stitching pattern 80 and having a common second warp portion 36b has the open portion of the C facing towards the left as shown on the drawings sheet (a backwards C). Thus, the pattern may also be described as a squared serpentine stitching pattern or square wave stitching pattern, specifically, a plurality of laterally offset, mutually aligned square wave patterns as each warp is aligned with or colinear with and laterally offset from the warp of the adjacent wave pattern. Or as illustrated in an embodiment in FIG. 3C an angularly modified stitching pattern for a stepped widening open C-shaped pattern or in the embodiment in FIG. 3D an angularly modified stitching pattern for a stepped closing C-shaped pattern. The stepped C-stitch pattern increases friction between the geotextile backing sheet and ground (or in a composite system, with the geomembrane) below. The stitching pattern enables the cover system of the present invention to be installed for covering applications on very steep slopes such as 2H:1V or steeper.

FIG. 3A illustrates in schematic diagram the tufting line stitching pattern 31 in accordance with the present invention having of the first weft portion 30, the first warp portion 32 disposed in a first direction at an oblique angle to the first weft portion, the second weft portion 34, and the second warp portion 36 in a second opposing direction at an oblique angle to the second weft portion, with tufts 24 at each corner or apex 37. At least one tuft 24 is also positioned along a weft portion 34 between adjacent corners 37 that define that weft portion 34. In the illustrated embodiment, the oblique angle is substantially perpendicular.

With reference to FIG. 3B illustrating in schematic diagram the tufts 24 of the tufting line stitching pattern and water flow having increased time of concentration. The tufts 24 extend from the opposing surface of the backing sheet to define the field of grass-like blades 36 with the tufts defining interstices therebetween. The interstices extend about the adjacent tufts from the upper surface of the backing sheet to the fill plane 49 defined by about the distal extent of the blades of the geotextile. The interstices provide water flow channels 43a and 43b. In a preferred embodiment in which the tuft gauge closely spaces adjacent lines 44 of tufts, the close proximity of the tuft 24a at an initiating apex of the first warp portion 32 relative to the tuft 24b at a terminating apex of the first warp portion 32 of the adjacent line minimizes an interstitial gap between the adjacent tufts of the adjacent lines of tufting. This provides for a diverting structure 45 within the water flow channel 43b and provides for increased time of concentration and beneficial reduction in flow and increased sand infill stability.

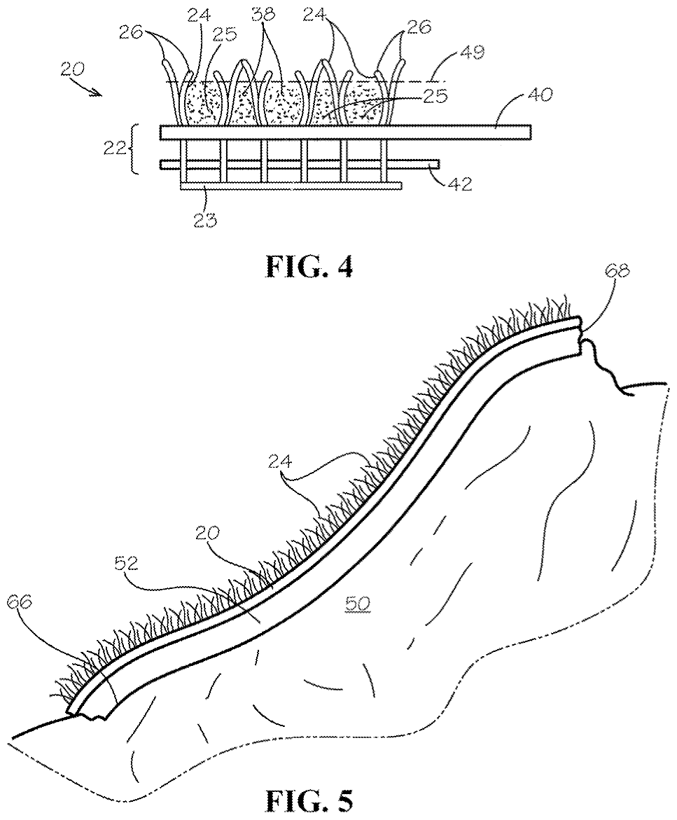

The backing sheet 22 has a weight basis or mass of between about 2 ounces per square yard to about 20 ounces per square yard. In the embodiment illustrated in exploded view in FIG. 4, the backing sheet 22 comprises a first backing sheet 40 and a second backing sheet 42. The tufting yarns interweave through the backing sheets 40, 42 to secure the backing sheets closely together with the spaced-apart spaced adjacent lines 44 of yarns that extend through the backing sheets to form the geotextile sheet 20 with the tufts of grass-like blades 26. The blades 26 extend from the backing sheet 22 about ½ inch to about 4 inches, and more preferably from about 1 inch to about 1 and ½ inches. The adjacent blades 26 define interstices 25 between the tufts 24. The interstices 25 receive a granular infill 38 selectively to a fill plane 49 (a greatest extent defined by about a distal extent of the blades 26).

The backing sheet 22 (or 40, 42) form of a polymer material that resists exposure to sunlight that generates heat rise in the geotextile 20 and that resists ultraviolet (UV) radiation in the sunlight, which degrades the geotextile backing sheet. The infill further provides UV covering protection for the backing sheet 22. The polymer yarns for the grass-like blades of the tufts further should not become brittle when subjected to low temperatures. The color selection of the yarns for the backing sheet 22 are preferably black and/or gray yarns. The color selection for the tufting yarns are green or brown, to simulate grasses. The tufts may be tufted in combinations for closer simulation of the natural area to be covered, for example using a respective proportion of a first, second, or more, color yarns. Further, the polymeric material for the yarns that are woven to form the backing sheet, or the polymers spun bond for a non-woven or woven backing sheet, include UV resistant additives such as HALS and carbon black. The polymers are selected to provide high shear strength resistance for the geotextile 20. The backing sheet has strong tensile strength, in a range of about 800 pounds per foot to about 4,000 pounds per foot.

### Tufted Geotextile

With continuing reference to FIGS. 1 and 2, the tufted geotextile 20 includes a tufting of closely spaced adjacent lines 44 of a stepped repeated C-shaped stitching pattern of tufts 24. As illustrated in FIG. 3, the illustrated embodiment tufts the yarns along spaced adjacent lines 44 with a tuft gauge 51 of about 0.25 inch between adjacent lines but may be up to about 0.5 inch spacing. Each spaced adjacent line 44 tufts with between about 20 tufts per foot to about 30 tufts per foot, and more preferably about 27 tufts per foot. In the illustrated embodiment the tufting stitching pattern repeats on about a ½ inch center spacing 53 but may range from about ¼ inch to about 1 inch. Embodiments of the cover geotextile 20 use between about 1,000-1400 tufts per square foot, and in the illustrated embodiment about 1,256 tufts per square foot. This tufting density reduces the gap or spacing between the blades 26, facilitates shadowing by the blades on the backing sheet 22 and portions of adjacent blades, and reduces UV exposure of the backing sheet to reduce geotextile degradation and damage to the ground cover. A dense tufting provides an increase in tuft density over linearly tufted geotextiles used previously with land site covering applications. The increase arises from changes in tuft gauge 51 (machine direction) and tuft row spacing 53 (cross-direction), with the beneficial effect of increased shadowing by the blades 26 of the geotextile sheet 22 and reduced interstitial spaces 25 between the blades 26 of the adjacent tufts 24. The stepped stitching pattern increases friction between the geotextile backing sheet and the ground (or in a composite system with the textured geomembrane) below. This enables application and installation of the cover system of the present invention on very steep slopes such as 2H:1V or steeper.

The adjacent tufts 24 cooperatively resist displacement of the infill 38 received in the tufted geotextile 20 due to loading such as hydraulic flow force of water across the cover. The tufting density thus may be increased up to and about 30% over linearly tufted lines of tufts with greater tuft gauge and tuft row spacing. Further, a preferred embodiment closely spaces adjacent lines of tufting to minimize a gap between respective tufts of adjacent lines as discuss above with reference to FIGS. 3A and 3B. The tuft gauge 51 in this embodiment is less than ½ inch to provide a gap of less than ¼ inch for adjacent tufts disposed for a diversion in the water flow channel 43b.

The grass-like component forming the blades 26 preferably consists of polyethylene fibers that when tufted, extend about 0.5 inches to about 4.0 inches from the backing sheet 22, more preferably about 1.0 inches to about 2.5 inches in length, tufted into the backing sheet. The embodiment illustrated in FIG. 4 having the first and second backing sheets 40, 42 tufted together provides increased slippage resistance, for example, resistance strength for use in severely steep side slopes, and provides as the first backing sheet 40 a waste layer for initial UV exposure and degradation during the operational life of the geotextile 20 while protecting the lower second backing sheet 42. The embodiment having the two, or more, layers of backing sheets 40, 42 tufted together affords improved dimensional stability having an increased lifetime duration.

The geotextile has a tensile strength of about 800 pounds per foot to about 4,000 pounds per foot.

The grass filaments formed by the tufted yarns preferably have an extended operational half-life of at least about 40 to about 50 years. The yarns for the tufts of synthetic grass blades are preferably polyethylene or polypropylene, or other polymeric.

### Infill

The tufted geotextile 20 provides a cover system for overlying a land surface. In an alternate embodiment, the cover system may gainfully use the granular infill 38 received within the backing sheets 22 (40, 42) and the interstices 25 between the tufts 24. The infill 38 is a granular material such as sand, sand-mixture, or solid particulate matter having sand characteristics, cooperating with the extending blades 26 of the tufts 24 to shadow the backing sheet 22 and to provide hydraulic head for water flow through the geotextile backing. The infill 38 fills onto the backing sheet 22 and within the interstices 25 therefrom to about a second extent that is generally less than the fill plane 49 of the geotextile. The infill 38 cooperates with the blades 46 to shadow the backing sheet 22 from UV exposure and degradation.

The infill 38 may be a sand material, and further particularly may comprise a fire retardant additive or product independent of a sand carrier mixture, such as a non-halogenated magnesium hydroxide powder, silicates including potassium silicate, calcium silicate, and sodium silicate, or other in situ fire suppression or resistant material.

The stepped tufting of the geotextile 20 in accordance with the invention provides high shear resistance to displacement or movement of the infill 38 arising from granular flow forces on the ground cover arising from wind, seismic, expansion from exposure to sun and subsequent contraction, vibrations, and water flow across the geotextile such as caused by rain storms over the covered land site. Rather, the tufting of the present invention resists infill movement and displacement. Particularly in events of water flow, the water flow is disrupted and slowed by the stepped tufts 24 and the infill develops hydraulic head for driving the water through the geotextile 20, and the water passes through the infill 38, and through the porous backing sheet 22. The water may then enter into the soil below the geotextile 20, or when used in a covering system for closure purposes of a land site, flow over a geomembrane disposed below the geotextile to a collection channel downslope.

The structure of the stitching pattern of the claimed covering system effectively provides for resistance to granular flow of the infill while providing increased friction coefficient between the geotextile and the ground below or in composite systems between the geotextile and the geomembrane below while enabling installation applications of the cover system on steeply sloped ground of 2H:1 V or steeper.

### Cover System for Landfill and Waste Site Closure

With reference to FIG. 5, the geotextile 20 readily installs over a ground surface 50 with the bottom in contact with the ground surface. The illustrated land site 50 includes a soil overlayment layer 52 that covers ground surface 50 or waste material such as in a landfill. The infill 38 provides additional mass for resisting wind uplift of the geotextile 20 and provides dimensional stability. The densely tufted geotextile 20 resists displacement of the infill 38 arising from hydraulic shear forces of water flow over the steep slopes (such as in a landfill), such that the granular loose infill 38 remains as placed in the interstices 25 even without a securing material such as cementitious granules that cure in place. The water flows over and around the blades 26 which disrupt flows, and the water passes through the infill 38 and the backing sheet 22 into the soil underneath.

### Geotextile and Geomembrane Closure System

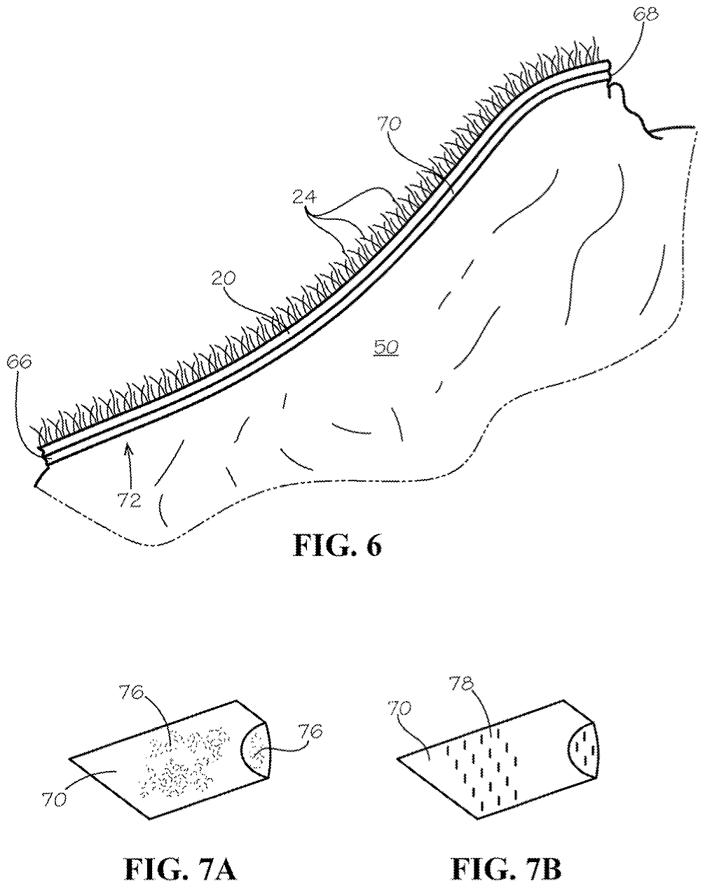

With reference to FIG. 6, the geotextile 20 readily installs alternatively with a geomembrane 70 for a closure covering system 72 for landfills and waste sites. These sites typically have steep slopes from the toe 66 to the apex 68, and may have slopes of up to about 45 degrees (i.e., 1H:1 V) with elevational differences of 200 feet or more. The geotextile 20 of the present invention readily installs for site covering or closure purposes without benches intermediate the toe 66 and apex 68, although benches may be employed.

The geomembrane 70 positions with a first surface overlying a land surface. The tufted geotextile 20 then overlies the geomembrane. The geomembrane 70 provides a frictional interface or a mechanical interface resistant to shear forces due to water or granular flow. As shown in FIGS. 7A and 7B, the geomembrane 70 may have opposing textured surfaces 76 and/or extending projections 78, and may have combinations (i.e., for example textured surface 76 on one side and projections 78 on an opposing side, for selective positioning on a ground surface or facing the back surface of the tufted geotextile). A smooth surface is not preferred, as such may lack sufficient dimensional stability under loading when applied in sloping applications.

As noted above, the geomembrane in one embodiment may include a plurality of projections 78, such as small spikes or studs that extend from one or both opposing surfaces which may have textured surfaces. In this embodiment, the projections pierce into, and mechanically engage with, the back surface of the backing sheet 22. This structure thus provides the cover system 72 having increased shear resistance to displacement of the tufted geotextile 20 relative to the geomembrane 70.

Further, in applications using infill 38, the increased resistance to shear forces resists hydraulic displacement or granular movement of the infill 38 in land site covering applications particularly on steeply sloped land sites. The penetration of the projections 68 into the geotextile 20 form the mechanical connection between the geomembrane 70 and the geotextile 20. The interface resistance to slippage is based upon the material strength of the geotextile and the projections in combination. The present invention provides high shear strength for a geotextile in a variety of applications including soil coverage and as a component of a closure system having the geomembrane and the geotextile to the resist slippage of the tufted geotextile relative to the geomembrane in response to hydraulic shear loading on the cover system.

The extending blades 26 shadow the interstices 25 of the geotextile 20 from the surface of the backing sheet 22 to a selected fill level, and may reach about the fill plane 49, and thus reduce exposure of the backing sheet 22 to UV and heat degradation.

The high density of the stepped tufts 24 increases the shear resistance of the geotextile 20 to infill displacement from dry granular flow loading caused by wind infiltration, subsurface ground vibrations, site contents settlement and vibrations, thermal expansions and contractions, and hydraulic displacement and movement caused by high water flow rates and volumes of water flow across the tufted geotextile. In covering applications that use infill 38, the geotextile 20 resists displacement and movement of the infill, particular hydraulic loading as water flows across the geotextile, through the infill and through the backing sheet 22 into the soil below with reduced displacement, movement and loss of the infill 48 from the interstices 25.

The foregoing discloses an improved geotextile having increased resistance to both dry flow arising from seismic, wind, and temperature (expansion and contraction) and wet flow hydraulic shear forces on the infill with decreased displacement and movement of the infill (either lost by (i) carry away in response to dry flow loading or flowing waters or (ii) creating thin or bare portions and over-filled portions of the cover system, requiring periodic maintenance) without the use of securing additives such as cement, and surprising and unexpected increase in friction resistance to geotextile creep and slippage relative to the ground surface or the impermeable membrane in the composite ground cover system, with increased time of concentration for water flow across the tufted geotextile. The heavy high-strength geotextile backing sheets are preferably made with a UV resistant polymer and the dense stepped tufting affords increased shading and cooperatively with the resultant reduced or non-moving infill protects the geotextile from UV degradation for cover system longevity and utility over longer multiple-year weathering periods experienced in covering and closing land site.

In the closure application, the geotextile secures in a first embodiment with the frictional interface to the geomembrane or secures in a second embodiment with the mechanical engagement.

The extending blades of the tufts in cooperation with the infill shadow the geotextile from UV exposure in the interstices from the geotextile to the fill depth while resisting displacement of infill in response to hydraulic shear loading on the cover system.

The fire additive provides a land surface covering resistant to fire.

The geotextile tufted and holding infill in interstice cells in the accordance with the present invention traps the infill from displacement from loading forces and as a result, maintains a uniformity of infill depth across the cover system while the hydraulic head is maintained for driving water faster from the cover, such as in combination closing cover systems to the underlying geomembrane which may have asperities such as pins, projections, or micro-spikes. The tufting cells having increased resistance to infill displacement enhances hydraulic drainage by increasing concentration of time and critical drainage length of the geomembrane due to lateral transmissivity of the infill providing improved lateral flow without shearing the infill.

The features disclosed for the improved geotextile lead to increased usage longevity in land site covering and closure system applications with increased shear resistance to displacement of infill while providing water flow control, and resistance to UV and heat degradation (including in alternate embodiment a waste sheet for initial term degradation protecting a second backing sheet), and fire resistance, for long term covering and closure of land sites.

Accordingly, the present invention provides an improved tufted geotextile for use with covering and closing land surfaces structured for infill stability by shear resistance to displacement from loading forces (such as generated by hydraulic, wind, seismic, vibrations, expansion and contraction loading, and the like), comprising:

at least one backing sheet tufted with yarns that extend from the backing sheet as simulated grass blades having interstices therebetween;

said tufts formed in lines of tufts each line having a stepped tuft line first axis and a spaced-apart tuft line second axis of repeating tufts defined by a first weft portion, a first warp portion disposed in a first direction at an angle to the first weft portion, a second weft portion, and a second warp portion in a second opposing direction at an angle to the second weft portion, to define tufts of yarns extending from a first face of the backing sheet as blades of simulated grass with interstices therebetween for receiving infill, and porous for permitting water flow through the geotextile, for resisting displacement and movement of the infill received in the interstices between adjacent tufts arising from granular flow loading forces.

The tufted geotextile readily overlies a ground surface for covering purposes as well as installs as a component in a closure system that uses an impermeable geomembrane for sealing closure, which stepped lines of tufts of the tufted geotextile exhibits improved shear resistance to infill displacement for steeply sloped land site covering and closure applications.

The present invention also provides for a synthetic turf cover system for erosion protection, wherein the synthetic turf cover system comprises a backing sheet; and synthetic grass blades extending above and through the backing sheet, the synthetic grass blades being tufted into said backing sheet in a plurality of mutually aligned square wave patterns.

Each square wave pattern of the plurality of mutually aligned square wave patterns includes a series of corners wherein each corner defines a transition between a warp portion and a weft portion, and wherein a synthetic grass blade is tufted into the backing sheet at each corner.

The present invention also provides for a synthetic turf cover system for erosion protection, wherein the synthetic turf cover system comprises a backing sheet; and synthetic grass blades extending above and through the backing sheet, the synthetic grass blades being tufted into said backing sheet in a plurality of alternating, interconnected “C-shaped” stitching patterns.

Each alternating, interconnected “C-shaped” stitching pattern includes a series of corners, wherein each corner defines a transition between a lateral portion and a longitudinal portion, and wherein a synthetic grass blade is tufted into the backing sheet at each corner.

The present invention also provides for a synthetic turf cover system for erosion protection, wherein the synthetic turf cover system comprises a backing sheet; and synthetic grass blades extending above and through the backing sheet. The synthetic grass blades being tufted into said backing sheet in a plurality of tufted sew lines, each tufted sew line having a plurality of longitudinal portions and a plurality of lateral portions, and wherein each adjacent pair of longitudinal portions of the plurality of longitudinal portions is spaced from each other by a lateral portion of the plurality of lateral portions.

Each tufted sew line includes a plurality of corners wherein each corner is defined by the intersection of one longitudinal portion with one lateral portion, and wherein the synthetic grass blade is tufted into the backing sheet at each corner of the plurality of corners.

### Illustrative Embodiments

The tufted synthetic grass ground cover of the present invention provides a structured pattern stitching of yarns to form tufts of synthetic grass-like blades extending from the backing sheet whereby the tufted synthetic grass ground cover balances interface friction between the underside or bottom surface of the backing sheet and granular/hydraulic flow resistance of granular ballast infill received in the interstices of the tufts so that the tufted synthetic grass ground cover remains engaged on sloping non-level surfaces (either in contact with ground or in contact with an impermeable geomembrane) while granular ballast is blocked from flowing movement by diverting tufts in water flow paths through the tufts above the upper surface of the backing sheet for increased dwell zone of water-carried ballast and reduced ballast displacement due to hydraulic shear of water flow on non-level sloping ground. As a result of the pattern stitching, the tufted synthetic grass ground cover uses less material yet resists ballast displacement while remaining engaged to the surface on which the tufted synthetic grass ground cover is overlaid by resisting shear force loading that induces cover movement. The stitching pattern of the tufts create diverting bottlenecks between adjacent tufts to resist water flow displacement of ballast.

The backing sheet is held on a movable bed during tufting by the pattern stitching of yarn with a needle bar configured for tufting movement of a needle and yarn vertically through the backing sheet (up and down), leaving a tuft of yarn extending the opposing side of the backing sheet. The backing sheet then moves for the next tufting position. In an embodiment, the bed holding the backing sheet moves to the next tufting position for operation of the needle bar. A simple pattern has three tufts, and the tufting defines a “V” shape of bridges on the bottom surface. The first tuft is formed at a “home” position. The next tufting position in this illustrative embodiment is on a bias relative to the first tuft. The bed moves the backing sheet longitudinally in the machine direction and laterally in a first direction transverse to the machine direction or cross-direction. Alternatively, the bed may move on a bias relative to the machine direction. After the second tuft is needle punched in the backing sheet, the bed moves the backing sheet to the third tuft position. The involves the bed moving in the machine direction and in a second opposing cross-direction (or alternatively on a second opposing bias). The “V” pattern is complete and the needle bar is at the home position. The tufting the repeats the pattern.

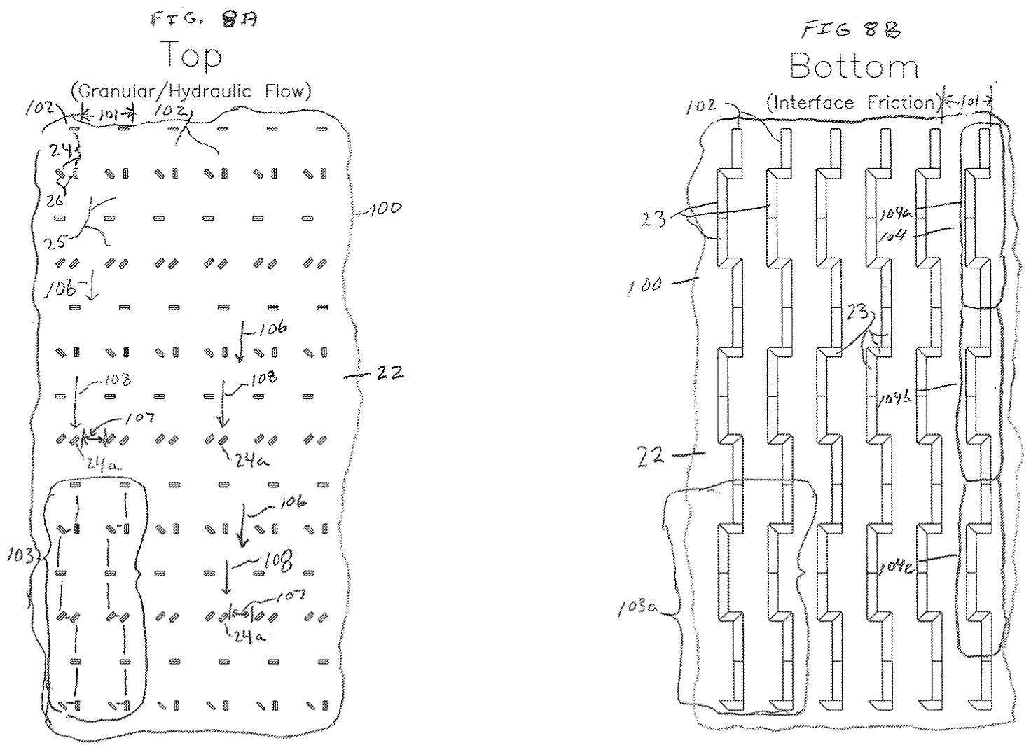

The yarn for tufting is preferably a flat slit polypropylene twisting into a round cross-section yarn onto a spool for tufting. During punching of the backing sheet 22 the yarn flattens out to define the grass-like blade elements 26, and the direction for the next tuft appears to orient the flat surface as show in FIGS. 8A-8B, 9A-9B, 10A-10B, and 11A-11B, illustrating tufting pattern embodiments discussed below.

More complicated stitching patterns may be tufted in the backing sheet. For example, a next tuft may be spaced but axially aligned with a preceding tuft in (a) the machine direction or (b) the cross-direction, relative to the first tuft. For a second tuft in (a) the machine direction, the bed moves in the machine direction a first predetermined distance. For a second tuft in (b) the cross-direction, the bed moves in the cross direction a second predetermined distance.

In an alternate embodiment, the needle bar moves in the cross-direction while the bed holding the backing sheet moves in the machine direction.

FIGS. 8A-8B, 9A-9B, 10A-10B, and 11A-11B illustrate alternate embodiments of tufting pattern tufted synthetic grass ground covers in accordance with the present invention. The respective sets of drawings are aligned side-by-side to illustrate the -A drawing showing a top view cross-sectional of the backing sheet and extending tufts 24 with a respective tufting pattern in accordance with the present invention and the -B drawing showing the corresponding bottom view of the tufting pattern. The horizontal rows and vertical columns of tufts in the -A drawing correspond to the tuft points of the tuft bridges shown in the -B drawing. A tuft is formed at the end of each tuft bridge or segment of yarn.

The adjacent columns are spaced a predetermined gauge or distance apart. The gap between adjacent columns of tufts defines a water flow channel. A larger gauge provides a wider water flow channel that carries ballast downslope on non-level sloping ground installations. The present invention however provides narrowed portions of water flow channels, which narrowed portions create diversions and bottlenecks that resist displacement of ballast. The tufting pattern thereby limits the space in which water and/or ballast travels before impinging on a blocking tuft and thereby diverts.

FIG. 8A illustrates a top view cross-section of a portion of a first embodiment of a tufting pattern tufted synthetic grass ground cover 100 with tufts 24 in spaced relation in the backing sheet 22 based on a tufting gauge 101 and FIG. 8B illustrates a bottom plan view showing the tufting pattern of the first embodiment with the tufting bridges 23. The tufting bridges 23 are short segments of the yarn that terminate in a tufting through the backing sheet 22 to form the tuft 24 with the extending grass-like blades 26. For purposes of illustration a portion of FIG. 8A is marked 103 with lines between tufts 24 to show the correlation of the tufts with the bridges 23 shown in a portion 103b in FIG. 8B. FIG. 8B is illustrated to show the repeating tufting pattern 104 as repeats 104a, 104b, and 104c.

The tufting forms lines 102 of tufts spaced apart by the tuft gauge 101. The interstices 25 between adjacent tufts 24 receive infill 38 and define water flow paths 106. Generally, the ground cover 100 overlies non-level sloping ground with the upper portion of the drawing sheet depicting an upper elevation. Portions 108 of the water flow paths 106 terminate with a diverting tuft 24a shown in FIG. 8A. The diverting tuft 24a creates a flow impediment or bottleneck. The infill ballast 38 may flow laterally around the diverting tuft 24a. Also rough surface infill ballast 38 may collect at the diverting tuft 24a and collect with other particles of the infill ballast to form a blocking across the flow channel. The stitching pattern of the present invention provides a gap 107 in portions of the ground cover that is narrower than the tuft gauge 101. The repeating stitching pattern thereby creates the plurality of diverting tufts 24a that diverts or obstructs flow of water and ballast across the tufted ground cover and increasing drainage critical length for water flow across the cover system. The stitching pattern of tuft bridges 23 in alternating patterns of yarn segments in both machine direction and transverse direction as illustrated in FIG. 8B creates interface friction between the backing sheet 22 and the ground or with the implementable geomembrane 70 used for an impermeable ground cover system. The texture 76 or projections 78 (such as spikes, barbs, studs, pins, or extending fingers or protrudences) of the geomembrane 70 engage the bridges 23 for a frictional interface or mechanical engagement of the synthetic grass backing sheet 22 with the geomembrane and the ground.

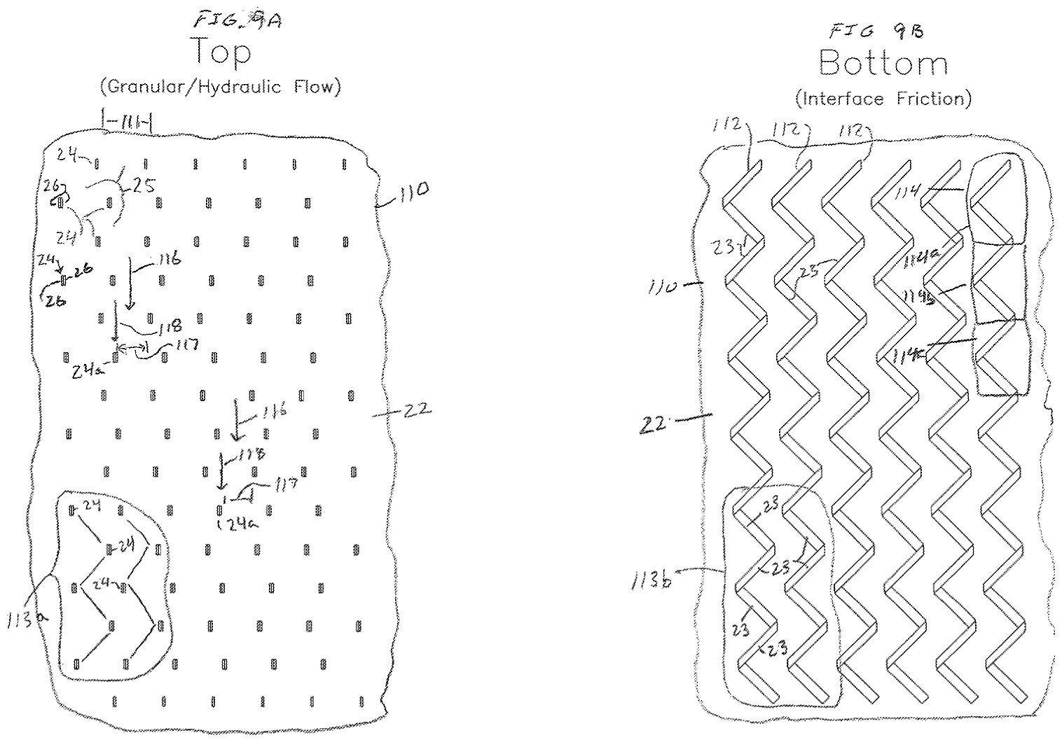

FIG. 9A illustrates a top view cross-section of a portion of a second illustrative embodiment of a tufting pattern tufted synthetic grass ground cover 110 with tufts 24 in spaced relation in the backing sheet 22 based on a tufting gauge 111 and FIG. 8B illustrates a bottom plan view showing the tufting pattern of the second embodiment with the tufting bridges 23. For purposes of illustration a portion of FIG. 9A is marked 113a with lines interconnecting the tufts 24 to show the correlation of the tufts with the bridges 23 shown in a portion 113b in FIG. 9B. FIG. 9B is illustrated to show the repeating tufting pattern 124 as repeats 114a, 114b, and 114c.

The tufting forms lines 112 of tufts spaced apart by the tuft gauge 101. The interstices 25 between adjacent tufts 24 receive infill 38 and define water flow paths 116. Generally, the ground cover 110 overlies non-level sloping ground with the upper portion of the drawing sheet depicting an upper elevation. Portions 118 of the water flow paths 116 terminate with a diverting tuft 24a shown in FIG. 9A. The diverting tuft 24a creates a flow impediment or bottleneck. The infill ballast 38 may flow laterally around the diverting tuft 24a. Also rough surface infill ballast 38 may collect at the diverting tuft 24a and collect with other particles of the infill ballast to form a blocking across the flow channel. The stitching pattern of the present invention provides a gap 117 in portions of the ground cover that is narrower than the tuft gauge 101. The repeating stitching pattern thereby creates the plurality of diverting tufts 24a that diverts or obstructs flow of water and ballast across the tufted ground cover and increasing drainage critical length for water flow across the cover system. The stitching pattern of tuft bridges 23 in alternating patterns of yarn segments in both machine direction and transverse direction as illustrated in FIG. 9B creates interface friction between the backing sheet 22 and the ground or with the implementable geomembrane 70 used for an impermeable ground cover system. The texture 76 or projections 78 (such as spikes, barbs, studs, pins, or extending fingers or protrudences) of the geomembrane 70 engage the bridges 23 for a frictional interface or mechanical engagement of the synthetic grass backing sheet 22 with the geomembrane and the ground.

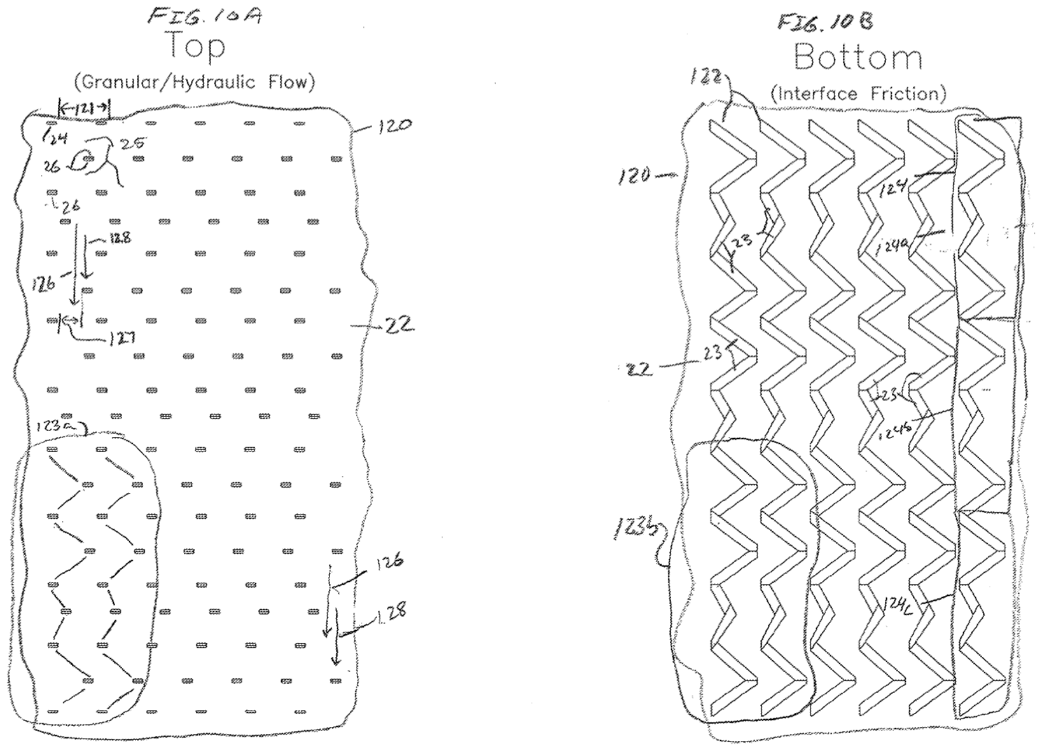

FIG. 10A illustrates a top view cross-section of a portion of a third illustrative embodiment of a tufting pattern tufted synthetic grass ground cover 120 with tufts 24 in spaced relation in the backing sheet 22 based on a tufting gauge 121 and FIG. 10B illustrates a bottom plan view showing the tufting pattern of the second embodiment with the tufting bridges 23. For purposes of illustration a portion of FIG. 10A is marked 123a with lines interconnecting the tufts 24 to show the correlation of the tufts with the bridges 23 shown in a portion 123b in FIG. 10B. FIG. 10B is illustrated to show the repeating tufting pattern 124 as repeats 124a, 124b, and 124c.

The tufting forms lines 122 of tufts spaced apart by the tuft gauge 121. The interstices 25 between adjacent tufts 24 receive infill 38 and define water flow paths 126. Generally, the ground cover 120 overlies non-level sloping ground with the upper portion of the drawing sheet depicting an upper elevation. Portions 128 of the water flow paths 126 terminate with a diverting tuft 24a shown in FIG. 10A. The diverting tuft 24a creates a flow impediment or bottleneck. The infill ballast 38 may flow laterally around the diverting tuft 24a. Also rough surface infill ballast 38 may collect at the diverting tuft 24a and collect with other particles of the infill ballast to form a blocking across the flow channel. The stitching pattern of the present invention provides a gap 127 in portions of the ground cover that is narrower than the tuft gauge 121. The repeating stitching pattern thereby creates the plurality of diverting tufts 24a that diverts or obstructs flow of water and ballast across the tufted ground cover and increasing drainage critical length for water flow across the cover system. The stitching pattern of tuft bridges 23 in alternating patterns of yarn segments in both machine direction and transverse direction as illustrated in FIG. 10B creates interface friction between the backing sheet 22 and the ground or with the implementable geomembrane 70 used for an impermeable ground cover system. The texture 76 or projections 78 (such as spikes, barbs, studs, pins, or extending fingers or protrudences) of the geomembrane 70 engage the bridges 23 for a frictional interface or mechanical engagement of the synthetic grass backing sheet 22 with the geomembrane and the ground.

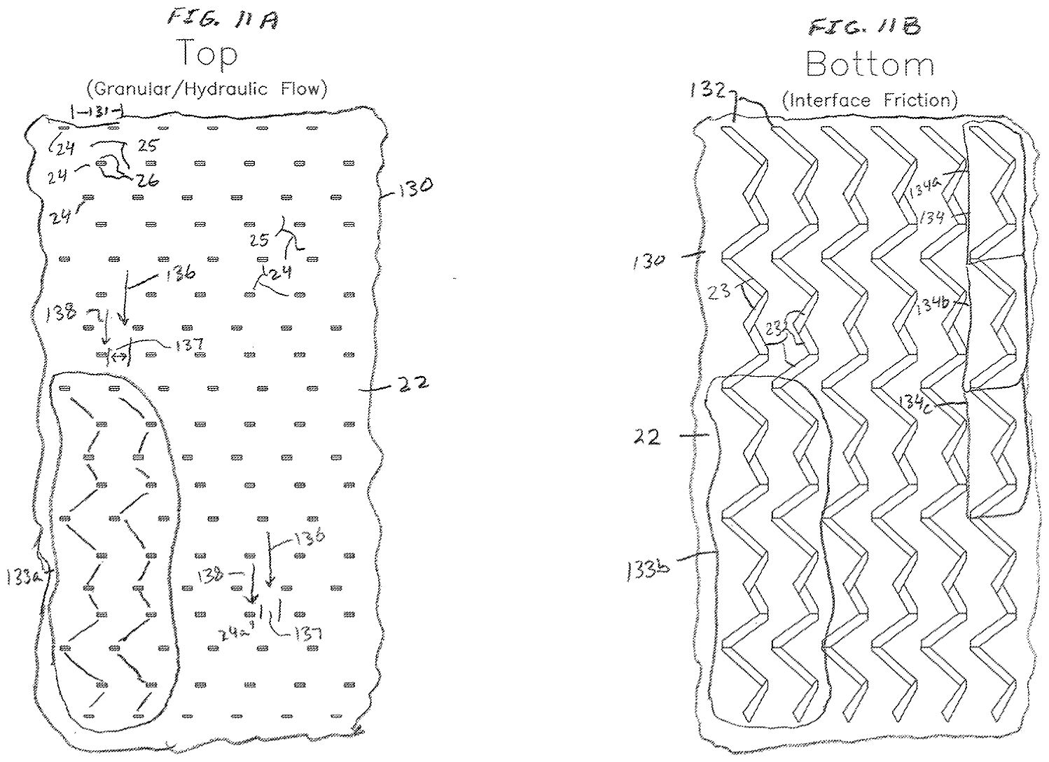

FIG. 11A illustrates a top view cross-section of a portion of a fourth illustrative embodiment of a tufting pattern tufted synthetic grass ground cover 130 with tufts 24 in spaced relation in the backing sheet 22 based on a tufting gauge 131 and FIG. 10B illustrates a bottom plan view showing the tufting pattern of the second embodiment with the tufting bridges 23. For purposes of illustration a portion of FIG. 11A is marked 133a with lines interconnecting the tufts 24 to show the correlation of the tufts with the bridges 23 shown in a portion 133b in FIG. 11B. FIG. 11B is illustrated to show the repeating tufting pattern 134 as repeats 134a, 134b, and 134c.

The tufting forms lines 132 of tufts spaced apart by the tuft gauge 131. The interstices 25 between adjacent tufts 24 receive infill 38 and define water flow paths 136. Generally, the ground cover 130 overlies non-level sloping ground with the upper portion of the drawing sheet depicting an upper elevation. Portions 138 of the water flow paths 136 terminate with a diverting tuft 24a shown in FIG. 11A. The diverting tuft 24a creates a flow impediment or bottleneck. The infill ballast 38 may flow laterally around the diverting tuft 24a. Also rough surface infill ballast 38 may collect at the diverting tuft 24a and collect with other particles of the infill ballast to form a blocking across the flow channel. The stitching pattern of the present invention provides a gap 137 in portions of the ground cover that is narrower than the tuft gauge 121. The repeating stitching pattern thereby creates the plurality of diverting tufts 24a that diverts or obstructs flow of water and ballast across the tufted ground cover and increasing drainage critical length for water flow across the cover system. The stitching pattern of tuft bridges 23 in alternating patterns of yarn segments in both machine direction and transverse direction as illustrated in FIG. 11B creates interface friction between the backing sheet 22 and the ground or with the implementable geomembrane 70 used for an impermeable ground cover system. The texture 76 or projections 78 (such as spikes, barbs, studs, pins, or extending fingers or protrudences) of the geomembrane 70 engage the bridges 23 for a frictional interface or mechanical engagement of the synthetic grass backing sheet 22 with the geomembrane and the ground.

It thus is seen that a stitching pattern geotextile ground cover system is now provided which addresses problems associated with the prior art. While this invention has been described in detail with particular references to the illustrative embodiments thereof, it should be understood that many modifications, additions and deletions, in addition to those expressly recited, may be made thereto without departure from the spirit and scope of the invention.

1. A geotextile cover system for use with covering and closing sloped land surfaces, comprising at least one backing sheet tufted with yarns that extend from the backing sheet as simulated grass blades having interstices therebetween and formed in spaced-apart lines of tufts, adjacent lines of tufts defining water flow channels in the interstices, each said line of tufts on a first predetermined spacing of the tufts and having a stepped tuft line first axis and a spaced-apart tuft line second axis of repeating spaced-apart tufts, said line of tufts defined by repeating patterns of a first weft portion, a first warp portion disposed in a first direction at an angle to the first weft portion, a second weft portion, and a second warp portion in a second opposing direction at an angle to the second weft portion, each weft and warp portion terminating in one of said tufts extending from a first face of the backing sheet as blades of simulated grass with interstices therebetween for receiving infill, said backing sheet porous for permitting water flow vertically through the tufted geotextile, said tuft of a terminated warp portion of the line of tufts disposed proximate said tuft of a terminated weft portion of an adjacent line of tufts on a second predetermined spacing less than the first predetermined spacing, wherein the tuft at the terminated weft portion of the adjacent line of tufts creates a diverter in the water flow channel between the adjacent lines of tufts for increasing water flow dwell and reducing water flow rate therein, said diverter ones of the tufts in the lines of tufts for resisting shear displacement and movement of the infill received in the interstices between adjacent tufts arising from granular flow loading forces for steeply sloped land site covering and closure applications.

2. The geotextile cover system as recited in claim 1, further comprising an impermeable geomembrane underlying the tufted geotextile for sealing closure of an overlaid surface for land site covering purposes.

3. The geotextile cover system as recited in claim 2, wherein the tufting defines bridge portions on a bottom surface of the geotextile that seat on the geomembrane to define a mechanical drainage for water flow above the geomembrane.

4. The geotextile cover system as recited in claim 3, wherein the surface of the geomembrane facing the tufted backing sheet is smooth.

5. The geotextile cover system as recited in claim 3, wherein the surface of the geomembrane facing the tufted backing sheet is textured.

6. The geotextile cover system as recited in claim 3, wherein the surface of the geomembrane facing the tufted backing sheet further comprises a plurality of spaced-apart projecting members that engage the yarn bridges of the tufted backing sheet.

7. The geotextile cover system as recited in claim 6, wherein a second surface of the geomembrane opposing the surface comprises a plurality of spaced-apart second projecting members for engaging a ground surface.

8. The geotextile cover system as recited in claim 1, wherein the infill comprises a granular material.

9. The geotextile cover system as recited in claim 1, wherein said line of tufts defines alternating first and second C-shaped tufting patterns, said first C-shaped tufting patterns open in a first direction and said second C-shaped tufting pattern open in a second opposing direction.

10. The geotextile cover system as recited in claim 9, wherein the tufts of the alternating first and second C-shaped tufting patterns define cells on an upper surface of the backing sheet for receiving the infill, for tufts opposing displacement of the infill.

11. The geotextile cover system as recited in claim 1, wherein the first weft portion and the second weft portion are of an equal length.

12. The geotextile cover system as recited in claim 1, wherein the first warp portion and the second warp portion are of an equal length.

13. The geotextile cover system as recited in claim 1, wherein the first warp portion comprises a first segment and a second segment each terminating in a tuft extending upwardly from an opposing side of the backing sheet.

14. The geotextile cover system as recited in claim 1, wherein the first weft portion and the second weft portion are of an equal first length, the first warp portion and the second warp portion are of an equal second length, and the second length is substantially equal to the first length.

15. The geotextile cover system as recited in claim 14, wherein the first warp portion and the second warp portion each comprises a first segment and a second segment with each segment terminating in a tuft extending upwardly from an opposing side of the backing sheet.

16. The geotextile cover system as recited in claim 1, wherein the first weft portion and the second weft portion are of an equal first length, the first warp portion and the second warp portion are of an equal second length, and the second length is greater than the first length.

17. The geotextile cover system as recited in claim 1, wherein adjacent lines of tufts have a tuft gauge for closely spacing an initiating apex of the first warp portion relative to the terminating apex of the first warp portion of the adjacent line for minimizing an interstitial gap between the adjacent tufts of the adjacent lines of tufting.

18. The geotextile cover system as recited in claim 1, wherein the backing sheet has a basis weight of about 2 ounces per square yard to about 20 ounces per square yard.

19. The geotextile cover system as recited in claim 1, in which the backing sheet comprises two or more geotextile sheets tufted together with polymeric yarns.

20. The geotextile cover system as recited in claim 1, wherein the backing sheet comprises a first geotextile and a second geotextile tufted together with a polymeric yarn for defining the tufts extending from the first geotextile.

21. The geotextile cover system as recited in claim 20, wherein the first geotextile and a second geotextile each have a basis weight totaling about 2 ounces per square yard to about 20 ounces per square yard.

22. The geotextile cover system as recited in claim 20, wherein the first geotextile and a second geotextile each have a basis weight of about 2 ounces per square yard to about 20 ounces per square yard.

23. The geotextile cover system as recited in claim 1, wherein the polymeric yarn includes UV resistant additives.

24. The geotextile cover system as recited in claim 1, wherein the polymeric yarn includes fire resistant additives.

25. The geotextile cover system as recited in claim 1, wherein the tufts in the adjacent stepped rows have a spacing gauge and spacing of adjacent rows to dispose tufts as a diverter structure in a water flow path between adjacent lines of tufts.

26. A cover system with high shear resistance for granular infill stability for covering sloped ground, comprising:
a geomembrane; and
a synthetic grass composite comprising a geotextile having a backing sheet with a plurality of spaced-apart tufts tufted with one or more synthetic yarns to form a plurality of elongated blades extending therefrom, said tufts tufted in stepped first and second spaced lines of repeating tufts defined by a first weft portion, a first warp portion disposed in a first direction at an angle to the first weft portion, a second weft portion, and a second warp portion in a second opposing direction at an angle to the second weft portion, the tufts defining interstices therebetween from the geotextile to a fill plane defined by about a distal extent of the blades, and porous for permitting water flow through the backing sheet, said tuft of a terminated warp portion of the line of tufts disposed proximate said tuft of a terminated weft portion of an adjacent line of tufts on a second predetermined spacing less than the first predetermined spacing, wherein the tuft at the terminated weft portion of the adjacent line of tufts creates a diverter in the water flow channel between the adjacent lines of tufts for increasing water flow dwell and reducing water flow rate therein, said diverter ones of the tufts in the lines of tufts to resist displacement and movement of the infill received in the interstices between adjacent tufts under loading,
said cover system for overlying a sloped ground surface for covering purposes while resisting granular infill displacement in response to shear loading including water flow and dry granular flow of infill resulting from wind, seismic, and thermodynamics of the synthetic geotextile that results in wrinkles in the cover.

27. The cover system as recited in claim 26, wherein the first warp portion comprises a first segment and a second segment each terminating in a tuft extending upwardly from the backing sheet.

28. The cover system as recited in claim 26, wherein the first weft portion and the second weft portion in the tufted geotextile are of a first length and the first warp portion and the second warp portion in the tufted geotextile are of a second length.

29. The cover system as recited in claim 28, wherein the second length is greater than the first length.

30. The cover system as recited in claim 26, wherein adjacent lines of tufting have a tuft gauge for closely spacing an initiating apex of the first warp portion relative to the terminating apex of the first warp portion of the adjacent line for minimizing an interstitial gap between the adjacent tufts of the adjacent lines of tufting.

31. The cover system as recited in claim 26, wherein the geotextile has a basis weight of at least about 2 ounces per square yard.

32. The cover system as recited in claim 26, further comprising a second geotextile tufted to the first geotextile.

33. The cover system as recited in claim 32, wherein the first geotextile and the second geotextile each have a respective basis weight totaling about at least 2 ounces per square yard.

34. The cover system as recited in claim 32, wherein the first geotextile and the second geotextile each have a basis weight of about at least 2 ounces per square yard.

35. The cover system as recited in claim 26, wherein the tufts are tufted in a line with a tuft gauge of about 27 tufts per foot machine direction.

36. The cover system as recited in claim 26, where adjacent tuft lines are spaced on about a ¼ inch center tuft gauge.

37. The cover system as recited in claim 26, wherein the geotextile has a tensile strength of about 800 pounds per foot to about 4,000 pounds per foot.

38. The cover system as recited in claim 26, wherein the geomembrane provides a frictional interface resistant to shear forces on the tufted geotextile.

39. The cover system as recited in claim 26, wherein the geomembrane provides a mechanical interface relative to a ground surface for resisting sliding thereover.

40. The cover system as recited in claim 26, wherein the geomembrane is selected from geomembranes having opposing textured surfaces, geomembranes having a first surface with a plurality of extending projections, geomembranes having a first textured surface and an opposing surface with a plurality of extending projections, and geomembranes having opposing surfaces each with a respective plurality of extending projections for engaging a ground surface below and the textured geotextile above.

41. The cover system as recited in claim 26, wherein the polymeric yarns include UV resistant additives.

42. The cover system as recited in claim 26, wherein the geotextile has a fire retardant additive.

43. A synthetic turf cover system for erosion protection on sloped ground, wherein the synthetic turf cover system comprises:
a backing sheet; and
synthetic grass blades extending above and through said backing sheet, said synthetic grass blades being tufted into said backing sheet in a plurality of laterally offset, mutually aligned square wave patterns;
said simulated grass blades having interstices therebetween and formed in spaced-apart lines of tufts, adjacent lines of tufts defining water flow channels in the interstices, each said line of tufts on a first predetermined spacing of the tufts and having a stepped tuft line first axis and a spaced-apart tuft line second axis of repeating spaced-apart tufts, said line of tufts defined by repeating patterns of a first weft portion, a first warp portion disposed in a first direction at an angle to the first weft portion, a second weft portion, and a second warp portion in a second opposing direction at an angle to the second weft portion, each weft and warp portion terminating in one of said tufts extending from a first face of the backing sheet as blades of simulated grass with interstices therebetween for receiving infill, said backing sheet porous for permitting water flow vertically through the tufted geotextile, said tuft of a terminated warp portion of the line of tufts disposed proximate said tuft of a terminated weft portion of an adjacent line of tufts on a second predetermined spacing less than the first predetermined spacing, wherein the tuft at the terminated weft portion of the adjacent line of tufts creates a diverter in the water flow channel between the adjacent lines of tufts for increasing water flow dwell and reducing water flow rate therein, said diverter ones of the tufts in the lines of tufts for resisting shear displacement and movement of the infill received in the interstices between adjacent tufts arising from granular flow loading forces for steeply sloped land site covering and closure applications.

44.-59. (canceled)
